(19) United States
(12) Patent Application Publication
(10) Pub. No.: US 2025/0066664 A1
(43) Pub. Date: Feb. 27, 2025

(54) CO2 PIPELINE CORROSION

(71) Applicant: Air Products and Chemicals, Inc., Allentown, PA (US)

(72) Inventors: Venkataramanan Ravi, Macungie, PA (US); Eryk Remiezowicz, Osówiec (PL); Sameer V. Ghalsasi, Allentown, PA (US); Vipul S. Parekh, Allentown, PA (US); Micah S. Kiffer, Kutztown, PA (US); Michelle Roaf, Surrey (GB)

(73) Assignee: Air Products and Chemicals, Inc., Allentown, PA (US)

(21) Appl. No.: 18/782,195

(22) Filed: Jul. 24, 2024

Related U.S. Application Data
(60) Provisional application No. 63/533,989, filed on Aug. 22, 2023.

(51) Int. Cl. C09K 15/02

(52) U.S. Cl. CPC C09K 15/02

(57) ABSTRACT

A method for corrosion control is disclosed, wherein the method includes limiting all components involved in sulfuric acid formation to low levels. The components include, but may not be limited to oxygen, nitrogen oxides, sulfur oxides, and H2S. The method may also include maintaining the H2S level above typical pipeline concentrations to inhibit the reactions to form sulfuric acid in the pipeline.

### CROSS-REFERENCE TO RELATED APPLICATIONS

This application claims priority to U.S. Provisional Application 63/533,989 which was filed Aug. 22, 2023 and is incorporated herein by reference.

### BACKGROUND

Existing industrial processes such as power generation will need to capture carbon dioxide (CO2) to mitigate the effects of climate change. Carbon capture, ultilization and storage (CCS) may require the CO2 to be purified to remove harmful impurities such as water, oxygen, carbon monoxide, nitrogen oxides and sulfur oxides. Without purification, impurities may corrode pipelines and other equipment required to compress, transport, and sequester the CO2. Some anthropogenic sources such as from the steel, cement, and power industries, may have an increased level of contaminants compared to relatively clean sources such as hydrogen production or enhanced oil recovery.

A CCS network may require any combination of the following specifications: maintaining the CO2 in a phase suitable for transport, protecting infrastructure from dropout of liquid water and/or acid, reducing concentration of toxic compounds, prevent cross reaction when multiple CO2 sources use the same network, preventing degredation of the geological reservoir such as by pore blockage, maximizing pore space utilization, and optimizing project costs.

Corrosion in dense-phase and gas-phase CO2 pipelines may be cuased by two phenomena: carbonic acid formed by dissolving water in liquid CO2 and sulfuric acid formed by reactions of oxygen, sulfur oxides, nitrogen oxides, and/or water. Carbonic acid may corrode carbon steel pipelines, whereas sulfuric acid may condense in CO2 without any liquid water present and is much more corrosive.

CO2 may be dehydrated by temperature swing adsorption on solid sorbents or by liquid absorption in glycol. In the glycol method, some glycol is entrained by CO2 stream. During transport of CO2 at gaseous state, this may lead to glycol condensation in the pipeline, which is undesirable and may cause processing problems and corrosion. For gaseous pipelines, triethylene glycol (TEG) concentrations of 0.1 ppb is enough to cause liquid condensation which may damage carbon steel CO2 pipelines.

### BRIEF DESCRIPTION OF THE DRAWINGS

These drawings illustrate certain aspects of some of the embodiments of the present disclosure and should not be used to limit or define the disclosure:

FIG. 1 is a temperature-pressure plot of the phase diagram of carbon dioxide.

FIG. 2 is a plot of the solubility of water in CO2 as a function of pressure.

FIG. 3 is a plot of the solubility of TEG in CO2 as a function of pressure.

FIG. 4 is a plot of the solubility of MDEA in CO2 as a function of pressure.

### DETAILED DESCRIPTION

The present disclosure is directed to methods of reducing corrosion in a CO2 pipeline. The concentration of water and oxygen may be reduced to prevent the reaction of SO2 to form sulfuric acid. The concentration of H2S may be maintained in a ratio to oxidizing compounds such as SO2, O2, and NO2 to reduce SO2 before it can be oxidized to form sulfuric acid. Glycol-based drying may be avoided when CO2 is transported in a gas phase in carbon steel pipelines to prevent entrained glycol from condensing in the pipeline and corroding the carbon steel. Amine-based CO2 capture may be avoided when CO2 is transported in a gas phase in carbon steel pipelines to prevent amine from condensing in the pipeline and corroding the carbon steel. Prior art methods to prevent pipeline corrosion have included coating the pipe, adding corrosion inhibitors to the CO2, catalytically consuming impurities. Pipe coatings and corrosion inhibitors are expensive, and it may not be practical to remove impurities low enough to prevent formation of sulfuric acid in sufficient quantities to damage the pipe.

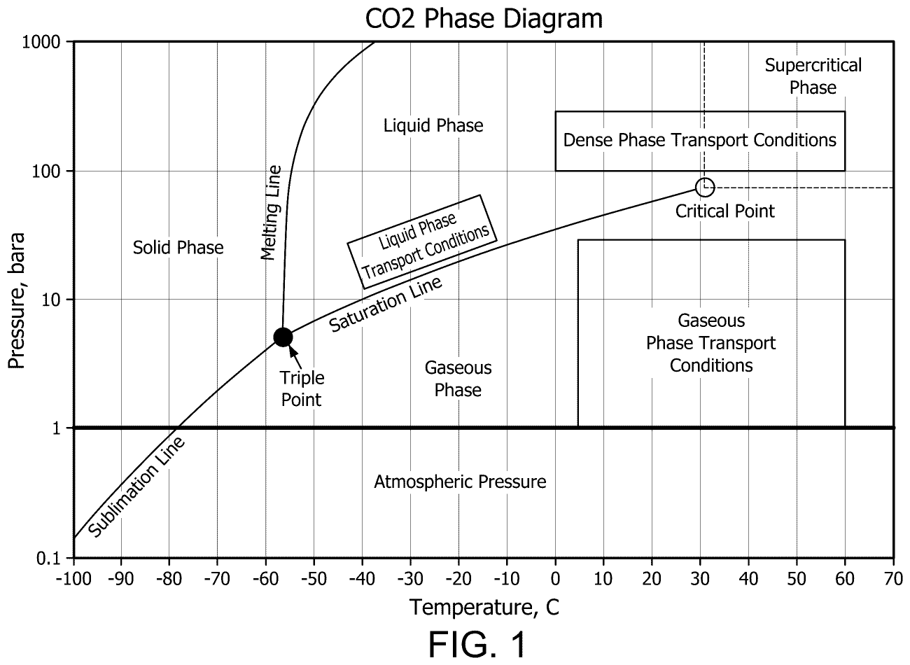

FIG. 1 is a temperature-pressure plot of the phase diagram of carbon dioxide. The critical point of 72.8 bara and 31° C. defines the point above which CO2 exists in a single, dense supercritical phase. Dense phase CO2 is defined as CO2 above the critical pressure of 72.8 bara at any temperature. Liquid phase CO2 is defined as CO2 below the critical pressure of 72.8 bara and at a pressure above the bubble point at the operating temperature. Gas phase CO2 is defined as CO2 below the critical pressure of 72.8 bara and at a temperature above the dew point at the operating temperature. For the pure-component CO2 diagram in FIG. 1, the bubble point and dew point trace the same saturation line.

Dense phase CO2 may be supercritical or liquid, however the phase change from liquid to supercritical CO2 by increasing temperature while pressure stays constant does not have a significant impact on the corrosion effects this disclosure addresses. Dense phase CO2 may range from 0-60° C., greater than 100 barg, greater than 95% purity on a volume basis, with less than 5 ppmv COS, less than 10 ppmv O2, less than 50 ppmv H2O, less than 5 ppmv H2S, less than 5 ppmv sulfur oxides, less than 10 ppmv nitrogen oxides, less than 8 ppmv glycols, and less than 10 ppmv total organic amines. Nitrogen oxides are of particular interest as NO2 may catalyze the reaction of SO2 to form sulfuric acid. In contrast, gas phase CO2 may range from 5-60° C., 0-34 barg, greater than 95% purity on a volume basis, with less than 5 ppmv COS, less than 10 ppmv O2, less than 50 ppmv H2O, less than 5 ppmv H2S, less than 5 ppmv sulfur oxides, less than 10 ppmv nitrogen oxides, less than 0.1 ppbv glycols, and less than 0.1 ppbv total organic amines.

Corrosion in a CO2 pipeline may be broadly divided into two categories: aqueous corrosion in the presence of a liquid water phase, and acid corrosion in the absence of a liquid water phase. Aqueous corrosion depends on the water dewpoint of the CO2 mixture and does not require bulk chemical reactions prior to phase separation. Mitigation of aqueous corrosion may be achieved through operation within a pre-determined pressure-temperature range. Aqueous corrosion therefore is of most concern in unplanned transient excursions from the planned operating range. Acid corrosion depends on the reaction of impurities such as water, nitrogen oxides, sulfur oxides, H2S, and O2 in the CO2 bulk. Acid corrosion may occur in steady-state conditions, nitrogen oxides may catalyze the reaction of sulfur oxides to sulfuric acid. Sulfuric acid may then separate into a liquid phase and absorb water from the CO2 mixture to form a highly corrosive acidic liquid phase.

While O2 is generally not corrosive below 1000 ppmv concentrations in CO2, it may react with other impurities present in CO2 such as sulfur oxides and nitrogen oxides to produce more corrosive compounds such as sulfuric acid. Concentrations of O2 ranging from 1 to 10 ppmv, or 1 to 5 ppmv, decreases the risk of generating undesirable byproducts such as sulfuric acid.

Sulfur oxides such as SO2 and SO3 can generate corrosive sulfuric acid, the latter by direct reaction with water and the former by catalytic oxidation by NO2 followed by reaction with water. Hydrogen sulfide may be oxidized to form SO2 as well.

SO2+H2O+1/202→H2SO4 (1)

H2S+3NO2→+3NO+SO2+H2O (2)

SO2+H2O+NO2→NO+H2SO4 (3)

2NO+O2→2NO2 (4)

SO3+H2O →H2SO4 (5)

COS+H2O →CO2+H2S (6)

Reaction 1 is known to have slow kinetics and only becomes significant for oxygen concentrations greater than 100 ppmv, or greater than 300 ppmv. Reactions 2 and 3 show how NO2 can convert H2S and SO2 to sulfuric acid. Reaction 4 regenerates NO2 when O2 is present, completing the catalytic cycle. However, because the rate of reaction 3 is slower than the rate of reaction 2, it allows the use of H2S to act as a scavenger, consuming NO2 before it can react with SO2 to generate sulfuric acid. H2S allows safe operation of CO2 pipelines in the presence of sulfur oxides and nitrogen oxides. The alternative to using H2S as a scavenger would be removing sulfur oxides and nitrogen oxides to ppbv levels to prevent corrosion, but removal to those low levels is not practical, especially when considering a pipeline accepting CO2 from multiple sources. A minimum concentration of H2S required to prevent corrosion may be calculated as equal to the total concentration of SO2, NO2, and O2, or equal to twice the total concentration of SO2, NO2, and O2. Given the typical concentrations of other impurities, the required concentration of H2S may range from 7 ppmv to 1900 ppmv, or from 7 ppmv to 1000 ppmv, or from 7 ppmv to 600 ppmv, or from 7 ppmv to 475 ppmv, or from 30 ppmv to 200 ppmv. The concentrations of H2S may be achieved by eliminating at least some upstream H2S removal and/or by adding H2S to a low-H2S stream to produce the carbon dioxide stream fed to the CO2 pipeline. Higher levels of H2S may allow increased levels of impurities such as H2O, O2, SO2, NO2, and NO. Concentrations of H2S ranging from 30 ppmv to 200 ppmv may allow concentrations of less than 40 ppmv O2, less than 500 ppmv H2O, less than 50 ppmv SO2, less than 0.1 ppmv SO3, less than 10 ppmv NO2, and less than 50 ppmv NO3.

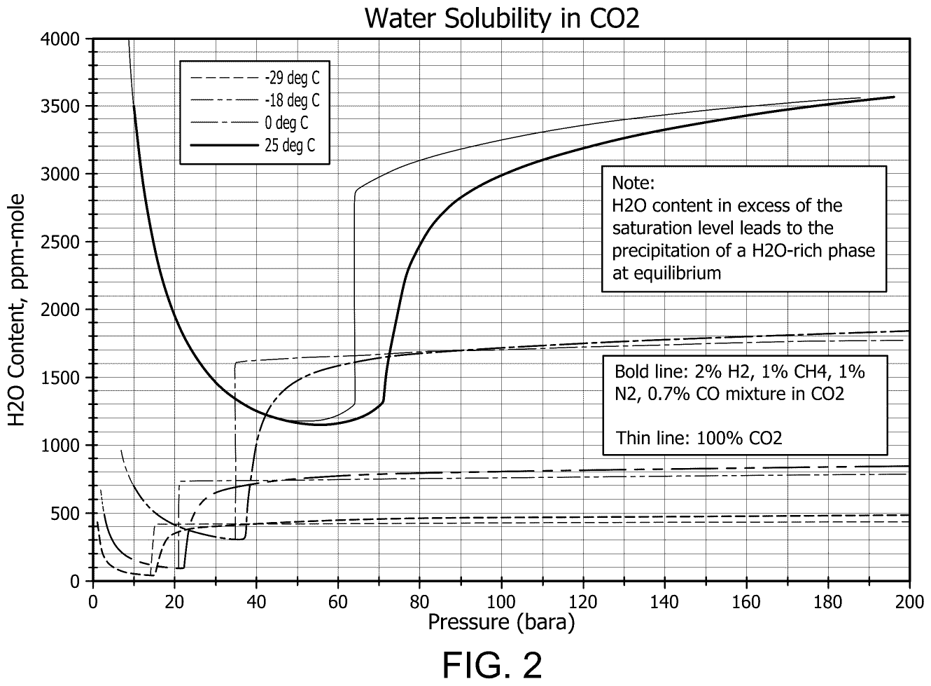

FIG. 2 is a plot of the solubility of water in CO2 as a function of pressure. Dashed lines show the solubility of water in pure CO₂ and solid lines show the solubility of water in CO2 with 2% H2, 1% CH4, 1% N2, and 0.7% CO. All concentrations are on a volume basis. The lower values of water solubility in the impure CO2 mixtures shows that relying solely on the thermodynamics of a pure CO2-H2O system may result in separation of a water-rich phase leading to carbonic acid corrosion, especially at higher temperatures. At −18° C. (0° F.), the solubility limit of water is around 90 ppmv for gas phase CO2 and about 740 ppmv for dense phase CO2. Operating in a range from 1 to 50 ppmv H2O, or from 1 to 25 ppmv H2O, provides a safe margin from the formation of an aqueous carbonic acid-rich phase. While in solution, however, water does not corrode pipe materials, so keeping water dissolved in the dense phase or gas phase CO2 mitigates corrosion.

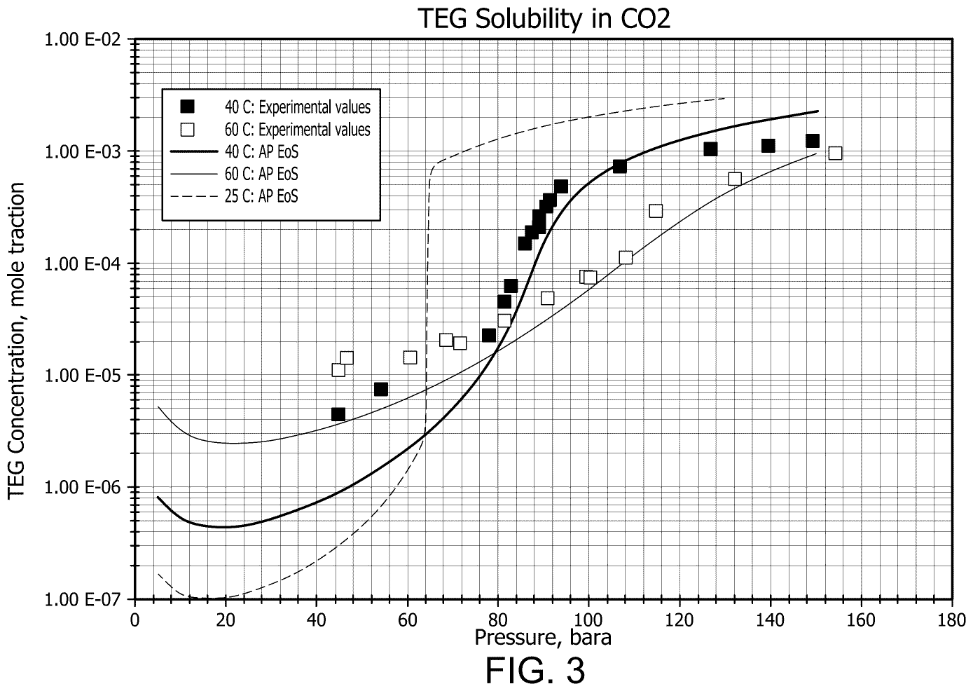

Glycols, such as triethylene glycol (TEG), may be used to dehydrate CO2 for CCS applications. In a separate liquid phase, glycols can both cause processing problems and corrosion. FIG. 3 is a plot of the solubility of TEG in CO2 as a function of pressure. In the gas phase, the solubility limit of TEG in CO2 at 25° C. (77° F.) is about 100 ppbv, which is not a specification achievable by conventional glycol removal. Therefore, for CCS applications using gas phase pipelines, TEG-based dehydration methods are not recommended.

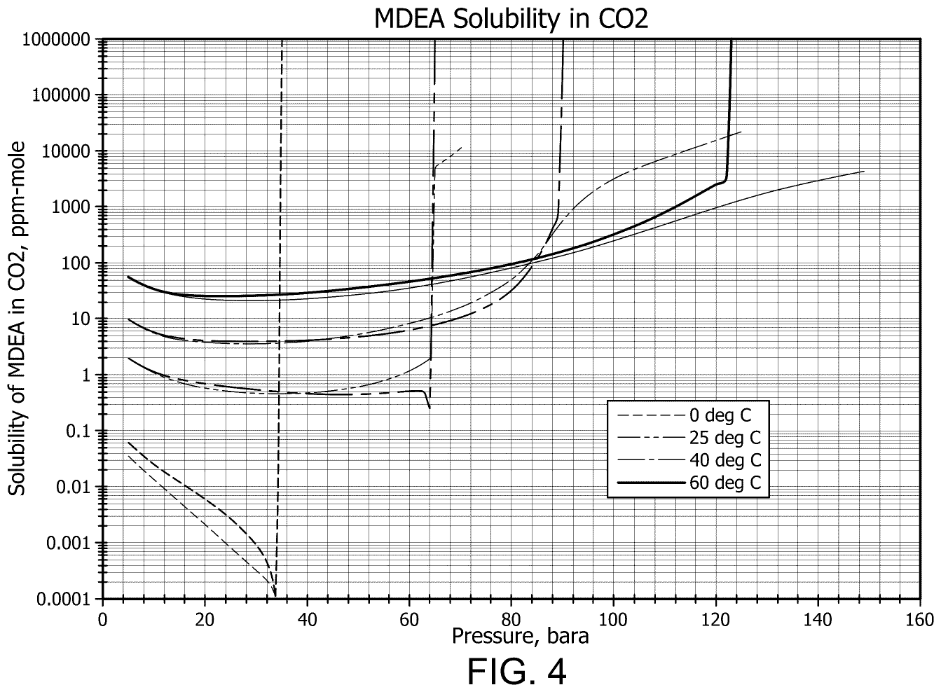

Amines such as methyl diethanol amine or MDEA may be used to capture CO2, and much like glycols, may separate out of solution in CO2 and cause processing problems and corrosion. FIG. 4 is a plot of the solubility of MDEA in CO2 as a function of pressure. In the gas phase, the solubility limit of MDEA in CO2 at 0° C. (32° F.) is about 0.1 ppbv. In addition to trace amines from the CO2 capture process, other amines resulting from the decomposition of the compounds used in CO2 capture may be present in higher concentrations. When using amines to capture CO2 that will be transported by gas phase pipeline, acid gas removal clean up units may be required to reduce amine carryover to acceptable levels. Alternatively, non-amine based CO2 capture processes such as vacuum swing adsorption, may be safely used for gas phase CCS applications.

Aspect 1: A method for corrosion control comprising transporting a carbon dioxide stream comprising H2S ranging from 7 ppmv to 1900 ppmv.

Aspect 2: A method according to Aspect 1, further comprising adding H2S to a low-H2S stream to produce the carbon dioxide stream.

Aspect 3: A method according to Aspect 1 or 2, wherein the carbon dioxide stream further comprises less than 50 ppmv SO2.

Aspect 4: A method according to any of Aspects 1 to 3, wherein the carbon dioxide stream further comprises less than 0.1 ppmv SO3.

Aspect 5: A method according to any of Aspects 1 to 4, wherein the carbon dioxide stream further comprises less than 50 ppmv NO.

Aspect 6: A method according to any of Aspects 1 to 5, wherein the carbon dioxide stream further comprises less than 10 ppmv NO2.

Aspect 7: A method according to any of Aspects 1 to 6, wherein the carbon dioxide stream further comprises less than 40 ppmv O2.

Aspect 8: A method according to any of Aspects 1 to 7, wherein the carbon dioxide stream further comprises less than 500 ppmv H2O.

Aspect 9: A method according to any of Aspects 1 to 8, wherein a pressure of the carbon dioxide stream is greater than 100 barg.

Aspect 10: A method according to any of Aspects 1 to 9, wherein a temperature of the carbon dioxide stream ranges from 0° C. to 60° C.

Aspect 11: A method according to any of Aspects 1 to 10, wherein the carbon dioxide stream comprises greater than 95% CO2 by volume.

Aspect 12: A method for corrosion control comprising transporting a carbon dioxide stream comprising less than 10 ppmv nitrogen oxides in a pipeline.

Aspect 13: A method according to Aspect 12, wherein the carbon dioxide stream further comprises less than 5 ppmv SO2.

Aspect 14: A method according to Aspect 12 or 13, wherein the carbon dioxide stream further comprises less than 0.1 ppmv SO3.

Aspect 15: A method according to any of Aspects 12 to 14, wherein the carbon dioxide stream further comprises less than 5 ppmv H2S.

Aspect 16: A method according to any of Aspects 12 to 15, wherein the carbon dioxide stream further comprises less than 50 ppmv H2O.

Aspect 17: A method according to any of Aspects 12 to 16, wherein the carbon dioxide stream further comprises less than 10 ppmv O2.

Aspect 18: A method according to any of Aspects 12 to 17, wherein a pressure of the carbon dioxide stream is greater than 100 barg.

Aspect 19: A method according to any of Aspects 12 to 18, wherein a temperature of the carbon dioxide stream ranges from 0° C. to 60° C.

Aspect 20: A method according to any of Aspects 12 to 19, wherein the carbon dioxide stream comprises greater than 95% CO2 by volume.

The ensuing detailed description provides preferred exemplary embodiments only, and is not intended to limit the scope, applicability, or configuration of the disclosure. Rather, the ensuing detailed description of the preferred exemplary embodiments will provide those skilled in the art with an enabling description for implementing the preferred exemplary embodiments of the disclosure. Various changes may be made in the function and arrangement of elements without departing from the spirit and scope of the disclosure, as set forth in the appended claims.

The articles “a” or “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

It should be understood that, although individual examples may be discussed herein, the present disclosure covers all combinations of the disclosed examples, including, without limitation, the different component combinations, method step combinations, and properties of the system.

### Examples

Using proprietary thermodynamic and kinetic data, safe levels of impurities were estimated for two levels of H2S in the bulk CO2 phase. Table 1 shows the concentrations in ppmv that provide a safe margin to avoid the formation of an aqueous or acid phase.

TABLE 1

| | Case 1 | Case 2 |
|---|---|---|
| H2S | <5 | 30-200 |
| O2 | <10 | <40 |
| H2O | <50 | <500 |
| SO2 | <5 | <50 |
| SO3 | <0.1 | <0.1 |
| NO2 | <2 | <10 |
| NO | | <50 |

Case 2 shows that for higher concentrations of H2S, higher concentrations of impurities such as O2, H2O, SO2, and NOx may be tolerated without increasing the risk of corrosion. Elevated levels of H2S both allow a significant decrease in pretreatment costs for CCS and simplify the mixing of various CO2 sources for a single CCS pipeline network.

While the principles of the invention have been described above in connection with preferred embodiments, it is to be clearly understood that this description is made only by way of example and not as a limitation of the scope of the invention.

1. A method for corrosion control comprising transporting a carbon dioxide stream comprising H2S ranging from 7 ppmv to 1900 ppmv.

2. The method of claim 1, further comprising adding H2S to a low-H2S stream to produce the carbon dioxide stream.

3. The method of claim 1, wherein the carbon dioxide stream further comprises less than 50 ppmv SO2.

4. The method of claim 1, wherein the carbon dioxide stream further comprises less than 0.1 ppmv SO3.

5. The method of claim 1, wherein the carbon dioxide stream further comprises less than 50 ppmv NO.

6. The method of claim 1, wherein the carbon dioxide stream further comprises less than 10 ppmv NO2.

7. The method of claim 1, wherein the carbon dioxide stream further comprises less than 40 ppmv O2.

8. The method of claim 1, wherein the carbon dioxide stream further comprises less than 500 ppmv H2O.

9. The method of claim 1, wherein a pressure of the carbon dioxide stream is greater than 100 barg.

10. The method of claim 1, wherein a temperature of the carbon dioxide stream ranges from 0° C. to 60° C.

11. The method of claim 1, wherein the carbon dioxide stream comprises greater than 95% CO2 by volume.

12. A method for corrosion control comprising transporting a carbon dioxide stream comprising less than 10 ppmv nitrogen oxides in a pipeline.

13. The method of claim 12, wherein the carbon dioxide stream further comprises less than 5 ppmv SO2.

14. The method of claim 12, wherein the carbon dioxide stream further comprises less than 0.1 ppmv SO3.

15. The method of claim 12, wherein the carbon dioxide stream further comprises less than 5 ppmv H2S.

16. The method of claim 12, wherein the carbon dioxide stream further comprises less than 50 ppmv H2O.

17. The method of claim 12, wherein the carbon dioxide stream further comprises less than 10 ppmv O2.

18. The method of claim 12, wherein a pressure of the carbon dioxide stream is greater than 100 barg.

19. The method of claim 12, wherein a temperature of the carbon dioxide stream ranges from 0° C. to 60° C.

20. The method of claim 12, wherein the carbon dioxide stream comprises greater than 95% CO2 by volume.
